(19) United States
(12) Patent Application Publication
(10) Pub. No.: US 2007/0002141 A1
(43) Pub. Date: Jan. 4, 2007

(54) Video-based human, non-human, and/or motion verification system and method

(75) Inventors: Alan J. Lipton, Herndon, VA (US); Himaanshu Gupta, Herndon, VA (US); Niels Haering, Reston, VA (US); Paul C. Brewer, Arlington, VA (US); Peter L. Venetianer, McLean, VA (US); Zhong Zhang, Herndon, VA (US); John I.W. Clark, Leesburg, VA (US)

Correspondence Address: VENABLE LLP, P.O. BOX 34385, WASHINGTON, DC, 20043-9998, US

(73) Assignee: ObjectVideo, Inc., Reston, VA (US)

(21) Appl. No.: 11/486,057

(22) Filed: Jul. 14, 2006

Related U.S. Application Data
(63) Continuation-in-part of application No. 11/139,972, filed on May 31, 2005.
(60) Provisional application No. 60/672,525, filed on Apr. 19, 2005.

(51) Int. Cl. H04N 7/18; H04N 9/47

(52) U.S. Cl. 348/155; 348/143; 348/152

(57) ABSTRACT

A video-based human, non-human, and/or motion verification system and method may include a video sensor adapted to obtain video and produce video output. The video sensor may include a video camera. The video-based human verification system may further include a processor adapted to process video to verify a human presence, a non-human presence, and/or motion. An alarm processing device may be coupled to the video sensor, the alarm processing device being adapted to receive video output or alert information from the video sensor.

### CROSS-REFERENCE TO RELATED APPLICATION

This application claims priority to U.S. patent application Ser. No. 11/139,972, filed on May 31, 2005, titled “Video-Based Human Verification System and Method, and U.S. Provisional Patent Application No. 60/672,525, filed on Apr. 19, 2005, titled “Human Verification Sensor for Residential and Light Commercial Applications,” both commonly-assigned, and both of which are incorporated herein by reference in their entirety.

### FIELD OF THE INVENTION

This invention relates to surveillance systems. Specifically, the invention relates to video-based human verification systems and methods.

### BACKGROUND OF THE INVENTION

Physical security is of critical concern in many areas of life, and video has become an important component of security over the last several decades. One problem with video as a security tool is that video is very manually intensive to monitor. Recently, there have been solutions to the problems of automated video monitoring in the form of intelligent video surveillance systems. Two examples of intelligent video surveillance systems are described in U.S. Pat. No. 6,696,945, titled “Video Tripwire” and U.S. patent application Ser. No. 09/987,707, titled “Surveillance System Employing Video Primitives,” both of which are commonly owned by the assignee of the present application and incorporated herein by reference in their entirety. These systems are usually deployed on large-scale personal computer (PC) platforms with large footprints and a broad spectrum of functionality. There are applications for this technology that are not addressed by such systems, such as, for example, the monitoring of residential and light commercial properties. Such monitoring may include, for example, detecting intruders or loiterers on a particular property.

Typical security monitoring systems for residential and light commercial properties may consist of a series of low-cost sensors that detect specific things such as motion, smoke/fire, glass breaking, door/window opening, and so forth. Alarms from these sensors may be situated at a central control panel, usually located on the premises. The control panel may communicate with a central monitoring location via a phone line or other communication channel. Conventional sensors, however, have a number of disadvantages. For example, many sensors cannot discriminate between triggering objects of interest, such as a human, and those not of interest, such as a dog. Thus, false alarms can be one problem with prior art systems. The cost of such false alarms can be quite high. Typically, alarms might be handled by local law enforcement personnel or a private security service. In either case, dispatching human responders when there is no actual security breach can be a waste of time and money.

Conventional video surveillance systems are also in common use today and are, for example, prevalent in stores, banks, and many other establishments. Video surveillance systems generally involve the use of one or more video cameras trained on a specific area to be observed. The video output from the video camera or video cameras is either recorded for later review or is monitored by a human observer, or both. In operation, the video camera generates video signals, which are transmitted over a communications medium to one or both of a visual display device and a recording device.

In contrast with conventional sensors, video surveillance systems allow differentiation between objects of interest and objects not of interest (e.g., differentiating between people and animals). However, a high degree of human intervention is generally required in order to extract such information from the video. That is, someone must either be watching the video as the video is generated or later reviewing stored video. This intensive human interaction can delay an alarm and/or any response by human responders.

### SUMMARY OF THE INVENTION

In view of the above, it would be advantageous to have a video-based human verification system that can verify the presence of a human in a given scene. The system may, in addition, be able to provide alerts based on other situations such as the presence of a non-human object (e.g., a vehicle, a house pet, or a moving inanimate object (e.g., curtains blowing in the wind) or the presence of any motion at all. In an exemplary embodiment, the video-based human verification system may include a video sensor adapted to capture video and produce video output. The video sensor may include a video camera. The video-based human verification system may further include a processor adapted to process video to verify the presence of a human. An alarm processing device may be coupled to the video sensor by a communication channel and may be adapted to receive at least video output through the communication channel.

In an exemplary embodiment, the processor may be included on the video sensor. The video sensor may be adapted to transmit alert information and/or video output in the form of, for example, a data packet or a dry contact closure, to the alarm processing device if the presence of a human, a non-human, or any motion at all is verified. The alarm processing device or a central monitoring center interface device may be adapted to transmit at least a verified human alarm to a central monitoring center and may also be adapted to transmit at least the video output to the central monitoring center. The alarm, optionally along with associated video and/or imagery, may also be sent directly to the property owner via a remote access web-page or via a wireless alarm receiving device.

In an exemplary embodiment, the processor may be included on the alarm processing device. The alarm processing device or interface device may be adapted to receive video output from the video sensor. The alarm processing device or the central monitoring center interface device may be further adapted to transmit alert information and/or video output to the central monitoring center if the presence of a human, a non-human, or any motion at all is verified. The alarm processing device or the central monitoring center interface device may also transmit the alarm, and optionally associated video and/or imagery, directly to the property owner via a remote access web-page or via a wireless alarm receiving device

In an exemplary embodiment, the processor may be included at the central monitoring center. The alarm processing device or the central monitoring center interface device may be adapted to receive video output from the video sensor and may further be adapted to retransmit the video output to the central monitoring center where the presence of a human, a non-human, or any motion at all may be verified.

Further objectives and advantages will become apparent from a consideration of the description, drawings, and examples.

### DEFINITIONS

In describing the invention, the following definitions are applicable throughout (including above).

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor or multiple processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a personal digital assistant (PDA); a portable telephone; application-specific hardware to emulate a computer and/or software, such as, for example, a digital signal processor (DSP) or a field-programmable gate array (FPGA); a distributed computer system for processing information via computer systems linked by a network; two or more computer systems connected together via a network for transmitting or receiving information between the computer systems; and one or more apparatus and/or one or more systems that may accept data, may process data in accordance with one or more stored software programs, may generate results, and typically may include input, output, storage, arithmetic, logic, and control units.

“Software” may refer to prescribed rules to operate a computer. Examples of software may include software; code segments; instructions; computer programs; and programmed logic.

A “computer system” may refer to a system having a computer, where the computer may include a computer-readable medium embodying software to operate the computer.

A “network” may refer to a number of computers and associated devices that may be connected by communication facilities. A network may involve permanent connections such as cables or temporary connections such as those made through telephone or other communication links. Examples of a network may include: an internet, such as the Internet; an intranet; a local area network (LAN); a wide area network (WAN); and a combination of networks, such as an internet and an intranet.

“Video” may refer to motion pictures represented in analog and/or digital form. Examples of video may include television, movies, image sequences from a camera or other observer, and computer-generated image sequences. Video may be obtained from, for example, a live feed, a storage device, an IEEE 1394-based interface, a video digitizer, a computer graphics engine, or a network connection.

A “video camera” may refer to an apparatus for visual recording. Examples of a video camera may include one or more of the following: a video imager and lens apparatus; a video camera; a digital video camera; a color camera; a monochrome camera; a camera; a camcorder; a PC camera; a webcam; an infrared (IR) video camera; a low-light video camera; a thermal video camera; a closed-circuit television (CCTV) camera; a pan, tilt, zoom (PTZ) camera; and a video sensing device. A video camera may be positioned to perform surveillance of an area of interest.

“Video processing” may refer to any manipulation of video, including, for example, compression and editing.

A “frame” may refer to a particular image or other discrete unit within a video.

### BRIEF DESCRIPTION OF THE SEVERAL VIEW OF THE DRAWINGS

The foregoing and other features and advantages of the invention will be apparent from the following, more particular description of exemplary embodiments of the invention, as illustrated in the accompanying drawings wherein like reference numerals generally indicate identical, functionally similar, and/or structurally similar elements. The left-most digits in the corresponding reference numerals indicate the drawing in which an element first appears.

FIG. 1 schematically depicts a video-based human verification system with distributed processing according to an exemplary embodiment of the invention;

FIG. 2 schematically depicts a video-based human verification system with distributed processing according to an exemplary embodiment of the invention;

FIG. 3 shows a block diagram of a software architecture for the video-based human verification system with distributed processing shown in FIGS. 1 and 2 according to an exemplary embodiment of the invention;

FIG. 4 schematically depicts a video-based human verification system with centralized processing according to an exemplary embodiment of the invention;

FIG. 5 schematically depicts a video-based human verification system with centralized processing according to an exemplary embodiment of the invention;

FIG. 6 shows a block diagram of a software architecture for the video-based human verification system with centralized processing shown in FIGS. 4 and 5 according to an exemplary embodiment of the invention;

FIG. 7 schematically depicts a video-based human verification system with centralized processing according to another exemplary embodiment of the invention;

FIG. 8 schematically depicts a video-based human verification system with centralized processing according to another exemplary embodiment of the invention;

FIG. 9 schematically depicts a video-based human verification system with distributed processing and customer data sharing according to an exemplary embodiment of the invention;

FIG. 10 schematically depicts a video-based human verification system with distributed processing and customer data sharing according to an exemplary embodiment of the invention;

FIGS. 11A-11D show exemplary frames of video input and output within a video-based human verification system utilizing obfuscation technologies according to an exemplary embodiment of the invention;

FIG. 12 shows a calibration scheme according to an exemplary embodiment of the invention.

FIG. 13 illustrates the selection of a best face according to an exemplary embodiment of the invention.

### DETAILED DESCRIPTION OF THE INVENTION

Exemplary embodiments of the invention are discussed in detail below. While specific exemplary embodiments are discussed, it should be understood that this is done for illustration purposes only. A person skilled in the relevant art will recognize that other components and configurations can be used without parting from the spirit and scope of the invention.

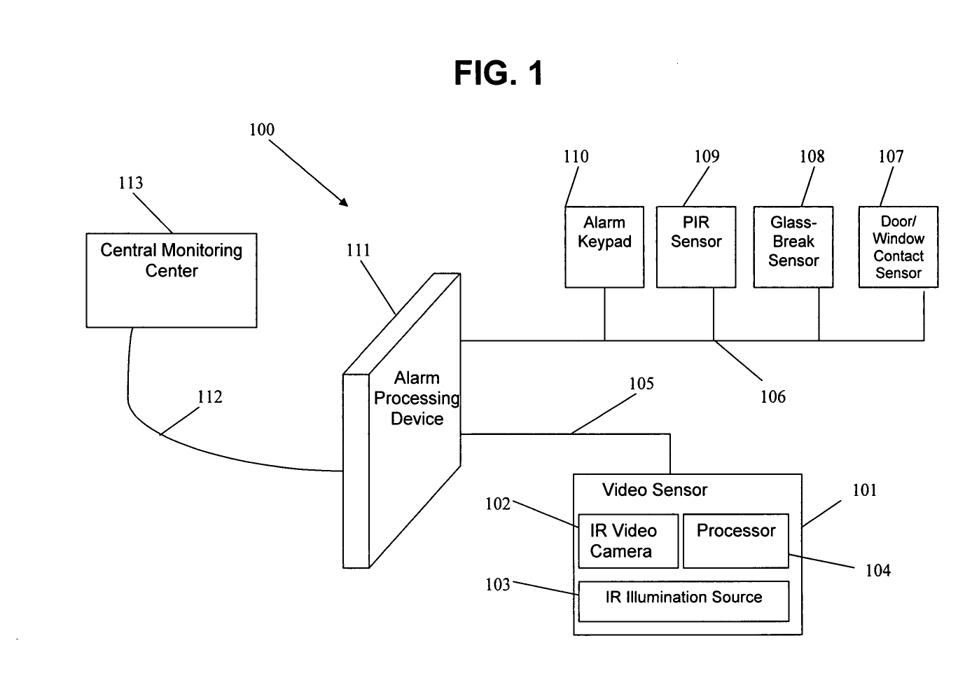

FIG. 1 schematically depicts a video-based human verification system 100 with distributed processing according to an exemplary embodiment of the invention. The system 100 may include a video sensor 101 that may be capable of capturing and processing video to determine the presence of a human in a scene. If the video sensor 101 verifies the presence of a human, it may transmit video and/or alert information to an alarm processing device 111 via a communication channel 105 for transmission to a central monitoring center (CMC) 113 via a connection 112.

The video sensor 101 may include an infrared (IR) video camera 102, an associated IR illumination source 103, and a processor 104. The IR illumination source 103 may illuminate an area so that the IR video camera 102 may obtain video of the area. The processor 104 may be capable of receiving and/or digitizing video provided by the IR video camera 102, analyzing the video for the presence of humans, non-humans, or any-motion at all, and controlling communications with the alarm processing device 111. The video sensor 101 may also include a programming interface (not shown) and communication hardware (not shown) capable of communicating with the alarm processing device 111 via communication channel 105. The processor 104 may be, for example: a digital signal processor (DSP), a general purpose processor, an application-specific integrated circuit (ASIC), field programmable gate array (FPGA), or a programmable device.

The human (or other object) verification technology employed by the processor 104 that may be used to verify the presence of a human, a non-human, and/or any motion at all in a scene may be the computer-based object detection, tracking, and classification technology described in, for example, the following, all of which are incorporated by reference herein in their entirety: U.S. Pat. No. 6,696,945, titled “Video Tripwire”; U.S. patent application Ser. No. 09/987,707, titled “Surveillance System Employing Video Primitives”; and U.S. patent application Ser. No. 11/139,986, titled “Human Detection and Tracking for Security Applications.” Alternatively, the human verification technology that is used to verify the presence of a human in a scene may be any other human detection and recognition technology that is available in the literature or is known to one sufficiently skilled in the art of computer-based human verification technology.

The communication channel 105 may be, for example: a computer serial interface such as recommended standard 232 (RS232); a twisted-pair modem line; a universal serial bus connection (USB); an Internet protocol (IP) network managed over category 5 unshielded twisted pair network cable (CAT5), fibre, wireless fidelity network (WiFi), or power line network (PLN); a global system for mobile communications (GSM), a general packet radio service (GPRS) or other wireless data standard; or any other communication channel capable of transmitting a data packet containing at least one video image.

The alarm processing device 111 may be, for example, an alarm panel or other associated hardware device (e.g., a set-top box, a digital video recorder (DVR), a personal computer (PC), a residential router, a custom device, a computer, or other processing device (e.g., a Slingbox by Sling Media, Inc. of San Mateo, Calif.)) for use in the system. The alarm processing device 111 may be capable of receiving alert information from the video sensor 101 in the form of, for example, a dry contact closure or a data packet including, for example: alert time, location, video sensor information, and at least one image or video frame depicting the human in the scene. The alarm processing device 111 may further be capable of retransmitting the data packet to the CMC 113 via connection 112. Examples of the connection 112 may include: a plain old telephone system (POTS), a digital service line (DSL), a broadband connection or a wireless connection.

The CMC 113 may be capable of receiving alert information in the form of a data packet that may be retransmitted from the alarm processing device 111 via the connection 112. The CMC 113 may further allow the at least one image or video frame depicting the human in the scene to be viewed and may dispatch human responders.

The video-based human verification system 100 may also include other sensors, such as dry contact sensors and/or manual triggers, coupled to the alarm processing device 111 via a dry contact connection 106. Examples of dry contact sensors and/or manual triggers may include: a door/window contact sensor 107, a glass-break sensor 108, a passive infrared (PIR) sensor 109, an alarm keypad 110, or any other motion or detection sensor capable of activating the video sensor 101. A strobe and/or a siren (not shown) may also be coupled to the alarm processing device 111 or to the video sensor 101 via the dry contact connection 106 as an output for indicating a human presence once such presence is verified. The dry contact connection 106 may be, for example: a standard 12 volt direct current (DC) connection, a 5 volt DC solenoid, a transistor-transistor logic (TTL) dry contact switch, or a known dry contact switch.

In an exemplary embodiment, the dry contact sensors, such as, for example, the PIR sensor 109 or other motion or detection sensor, may be connected to the alarm processing device 111 via the dry contact connection 106 and may be capable of detecting the presence of a moving object in the scene. The video sensor 101 may only be employed to verify that the moving object is actually human. That is, the video sensor 101 may not be operating (to save processing power) until it is activated by the PIR sensor 109 through the alarm processing device 111 and communication channel 105. As an option, at least one dry contact sensor or manual trigger may also trigger the video sensor 101 via a dry contact connection 106 directly connected (not shown) to the video sensor 101. The IR illumination source 103 may also be activated by the PIR sensor 109 or other dry contact sensor. In another exemplary embodiment, the video sensor 101 may be continually active.

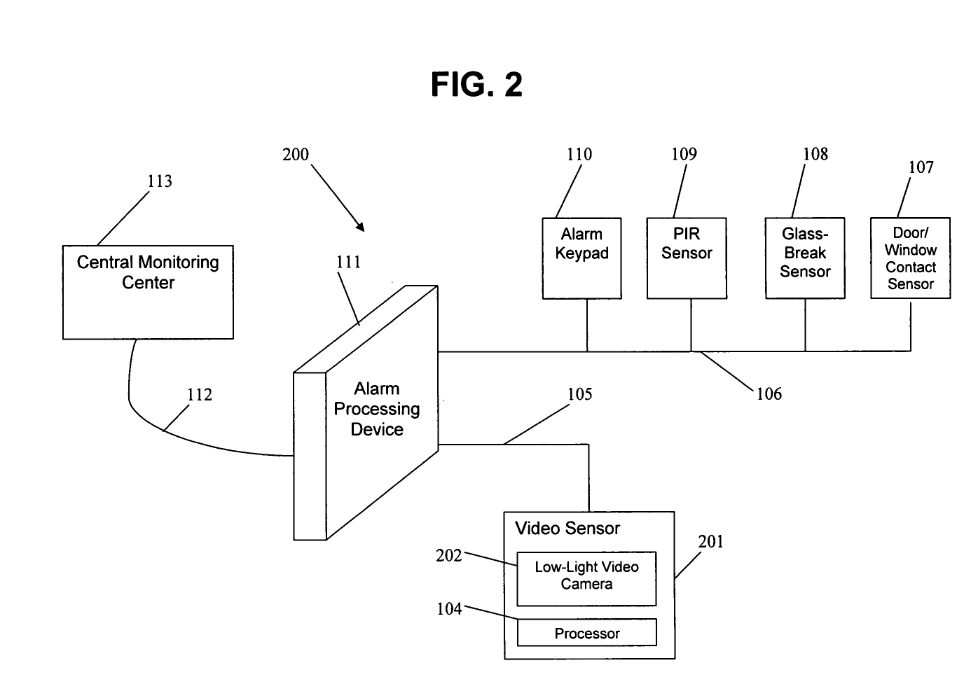

FIG. 2 schematically depicts a video-based human verification system 200 with distributed processing according to an exemplary embodiment of the invention. FIG. 2 is the same as FIG. 1, except that video sensor 101 is replaced by video sensor 201. The video sensor 201 may include a low-light video camera 202 and the processor 104. In this embodiment, the processor 104 may be capable of receiving and/or digitizing video captured by the low-light video camera 202, analyzing the captured video for the presence of humans, non-humans, and/or any motion at all, and controlling communications with the alarm processing device 111.

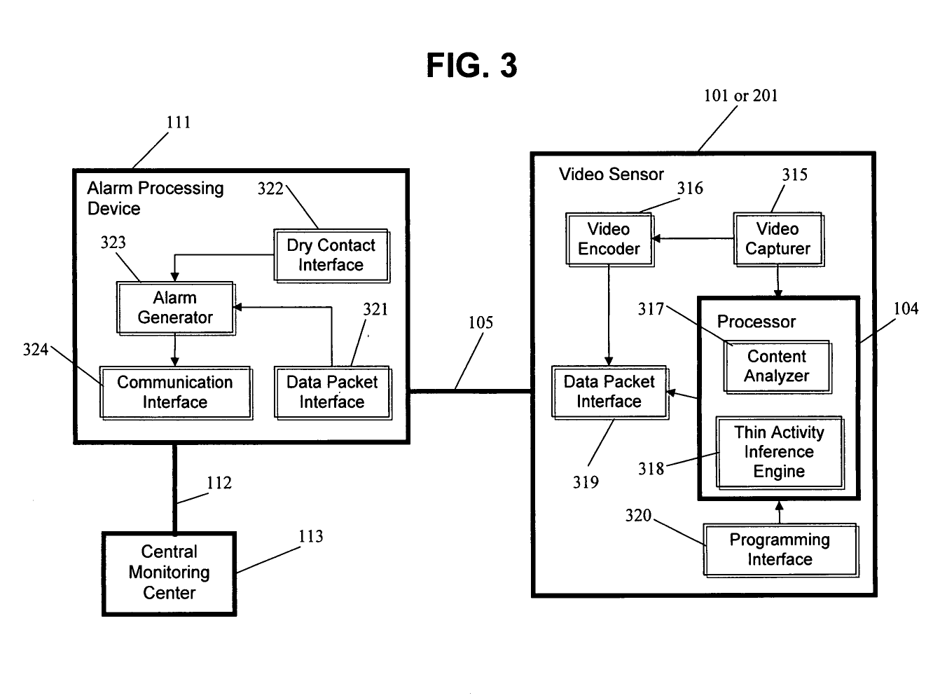

FIG. 3 shows a block diagram of a software architecture for the video-based human verification system with distributed processing shown in FIGS. 1 and 2 according to an exemplary embodiment of the invention. The software architecture of video sensor 101 and/or video sensor 201 may include the processor 104, a video capturer 315, a video encoder 315, a data packet interface 319, and a programming interface 320.

The video capturer 315 of the video sensor 101 may capture video from the IR video camera 102. The video capturer 315 of the video sensor 201 may capture video from the low-light video camera 202. In either case, the video may then be encoded with the video encoder 316 and may also be processed by the processor 104. The processor 104 may include a content analyzer 317 to analyze the video content and may further include a thin activity inference engine 318 to verify the presence of a human, a non-human, and/or any motion at al. in the video (see, e.g., U.S. patent application Ser. No. 09/987,707, titled “Surveillance System Employing Video Primitives”).

In an exemplary embodiment, the content analyzer 317 models the environment, filters out background noise, detects, tracks, and classifies the moving objects, and the thin activity inference engine 318 determines that one of the objects in the scene is, in fact, a human, a non-human, and/or any motion at all, and that this object is in an area where a human, a non-human, or motion should not be.

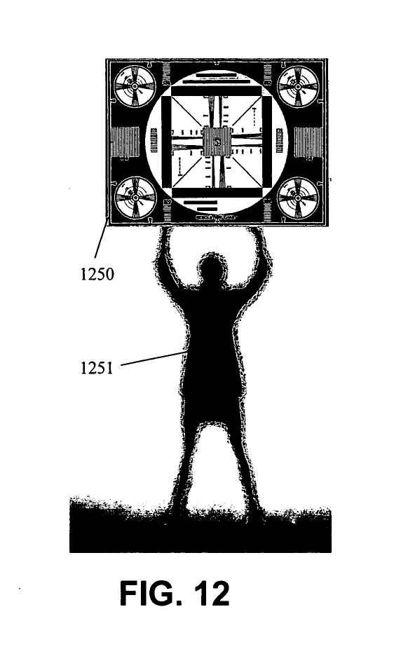

The programming interface 320 may control functions such as, for example, parameter configuration, human verification rule configuration, a stand-alone mode, and/or video camera calibration and/or setup to configure the camera for a particular scene. The programming interface 320 may support parameter configuration to allow parameters for a particular scene to be employed. Parameters for a particular scene may include, for example: no parameters; parameters describing a scene (indoor, outdoor, trees, water, pavement); parameters describing a video camera (black and white, color, omni-directional, infrared); and parameters to describe a human verification algorithm (for example, various detection thresholds, tracking parameters, etc.). The programming interface 320 may also support a human verification rule configuration. Human verification rule configuration information may include, for example: no rule configuration; an area of interest for human detection and/or verification; a tripwire over which a human must walk before he/she is detected; one or more filters that depict minimum and maximum sizes of human objects in the view of the video camera; one or more filters that depict human shapes in the view of the video camera. Similarly, The programming interface 320 may also support a non-human and/or a motion verification rule configuration. Non-human and/or motion verification rule configuration information may include, for example: no rule configuration; an area of interest for non-human and/or motion detection and/or verification; a tripwire over which a non-human must cross before detection; a tripwire over which motion must be detected; one or more filters that depict minimum and maximum sizes of non-human objects in the view of the video camera. The programming interface 320 may further support a stand-alone mode. In the stand-alone mode, the system may detect and verify the presence of a human without any explicit calibration, parameter configuration, or rule set-up. The programming interface 320 may additionally support video camera calibration and/or setup to configure the camera for a particular scene. Examples of camera calibration include: no calibration; self-calibration (for example, FIG. 12 depicts a calibration scheme according to an exemplary embodiment of the invention wherein a user 1251 holds up a calibration grid 1250); calibration by tracking test patterns; full intrinsic calibration by laboratory testing (see, e.g., R. Y. Tsai, “An Efficient and Accurate Camera Calibration Technique for 3D Machine Vision,” Proceedings of IEEE Conference on Computer Vision and Pattern Recognition, pp. 364-374, 1986, which is incorporated herein by reference); full extrinsic calibration by triangulation methods (see, e.g., Collins, R. T., A. Lipton, H. Fujiyoshi, T. Kanade, “Algorithms for Cooperative Multi-Sensor Surveillance,” Proceedings of the IEEE, October 2001, 89(10):1456-1477, which is incorporated herein by reference); or calibration by learned object sizes (see, e.g., U.S. patent application Ser. No. 09/987,707, titled “Surveillance System Employing Video Primitives”).

The video sensor data packet interface 319 may receive encoded video output from the video encoder 316 as well as data packet output from the processor 104. The video sensor data packet interface 319 may be connected to and may transmit data packet output to the alarm processing device 111 via communication channel 105.

The software architecture of the alarm processing device 111 may include a data packet interface 321, a dry contact interface 322, an alarm generator 323, and a communication interface 324 and may further be capable of communicating with the CMC 113 via the connection 112. The dry contact interface 322 may be adapted to receive output from one or more dry contact sensors (e.g., the PIR sensor 109) and/or one or more manual triggers (e.g., the alarm keypad 110), for example, in order to activate the video sensor 101 and/or video sensor 201 via the communication channel 105. The alarm processing device data packet interface 321 may receive the data packet from the video sensor data packet interface 319 via communication channel 105. The alarm generator 323 may generate an alarm in the event that the data packet output transmitted to the alarm processing device data packet interface 321 includes a verification that a human is present. The communication interface 324 may transmit at least the video output to the CMC 113 via the connection 112. The communication interface 324 may further transmit an alarm signal generated by the alarm generator 323 to the CMC 113.

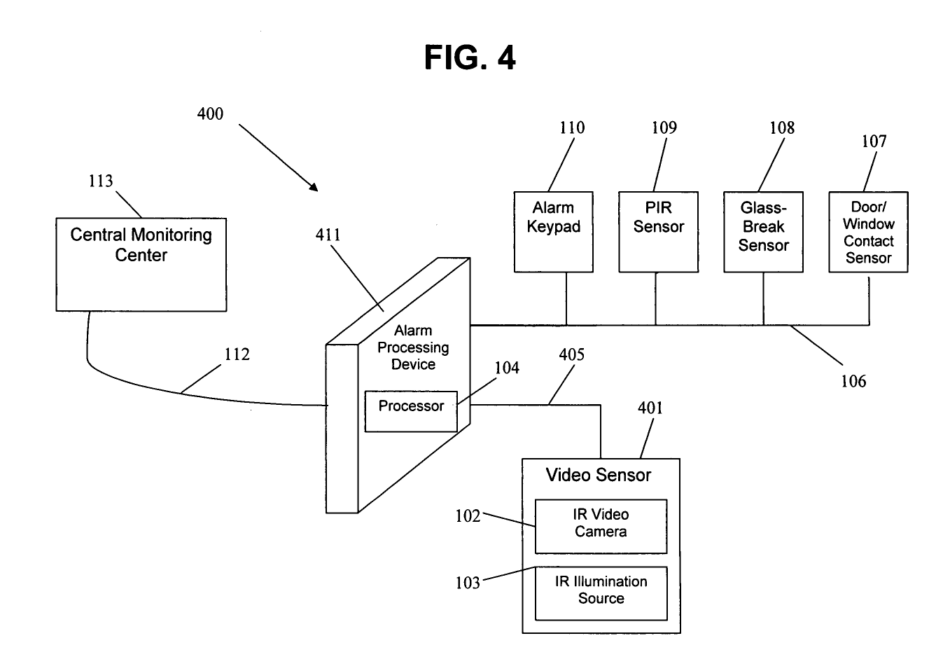

FIG. 4 schematically depicts a video-based human verification system 400 with centralized processing according to an exemplary embodiment of the invention. FIG. 4 is the same as FIG. 1, except that the processor 104 may be included in an alarm processing device 411 as in FIG. 4 rather than in the video sensor 101 as in FIG. 1. The system 400 may include a “dumb” video sensor 401 that may be capable of capturing and outputting video to the alarm processing device 411 via a communication channel 405. The alarm processing device 411 may be capable of processing the video to determine whether a human, a non-human, and/or any motion at all is present in the scene. If the alarm processing device 411 verifies the presence of a human, a non-human, and/or any motion at all, it may transmit the video and/or other information to the CMC 113 via the connection 112.

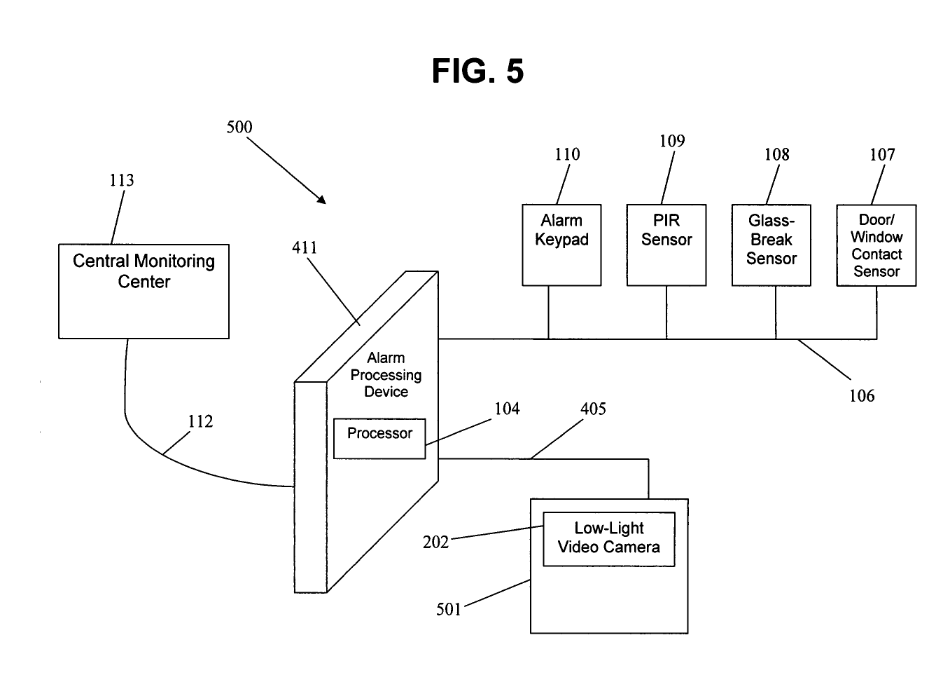

FIG. 5 schematically depicts a video-based human verification system 500 with centralized processing according to an exemplary embodiment of the invention. FIG. 5 is the same as FIG. 4, except that “dumb” video sensor 401 may be replaced by “dumb” video sensor 501. The video sensor 501 may include the low-light video camera 202.

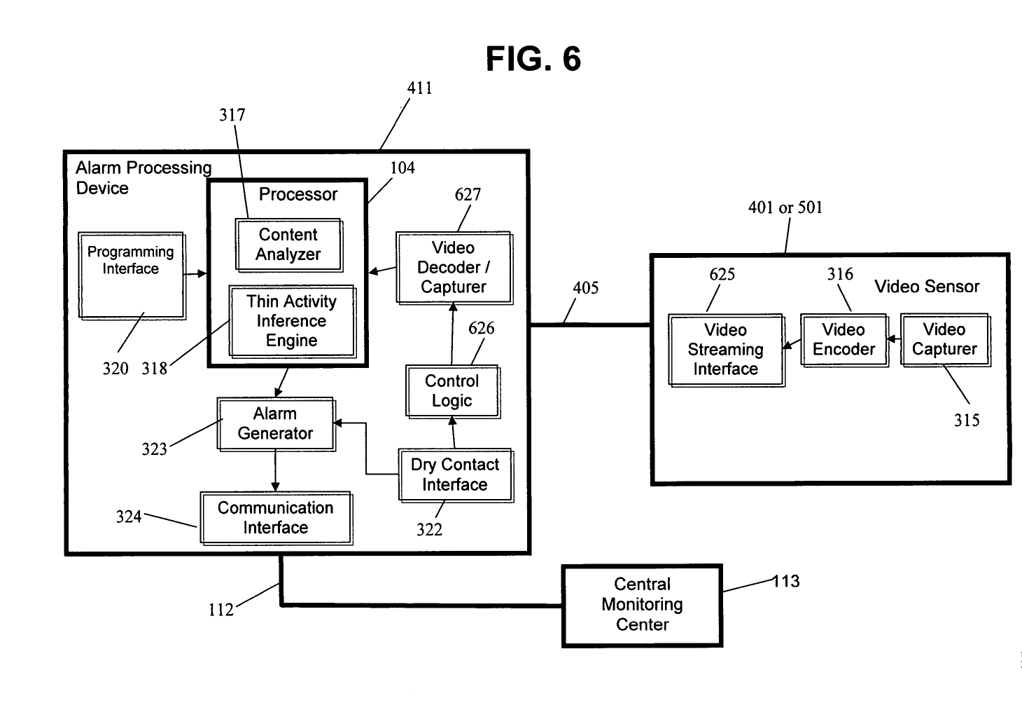

FIG. 6 shows a block diagram of a software architecture scheme for the video-based human verification system with centralized processing shown in FIGS. 4 and 5 according to an exemplary embodiment of the invention. The software architecture of the “dumb” video sensor 401 and/or video sensor 501 may include a video capturer 315, a video encoder 316, and a video streaming interface 625.

The video capturer 315 of the “dumb” video sensor 401 may capture video from the IR video camera 102. The video capturer 315 of the “dumb” video sensor 501 may capture video from the low-light video camera 202. In either case, the video may then be encoded with the video encoder 316 and output from a video steaming interface 625 to the alarm processing device 411 via communication channel 405.

The software architecture of the alarm processing device 411 may include the dry contact interface 322, a control logic 626, a video decoder/capturer 627, the processor 104, the programming interface 320, the alarm generator 323, and the communication interface 324. The dry contact interface 322 may be adapted to receive output from one or more dry contact sensors (e.g., the PIR sensor 109) and/or one or more manual triggers (e.g., the alarm keypad 110), for example, in order to activate the video sensor 401 and/or video sensor 501 via the communication channel 405. In a system having multiple video sensors 401, the dry contact output may pass to control logic 626. The control logic 626 determines which video source and which time range to retrieve video. For example, for a system with twenty non-video sensors and five partially overlapping video sensors 401 and/or 501, the control logic 626 determines which video sensors 401 and/or 501 are looking at the same area as which non-video sensors. The alarm processing device video decorder/capturer 627 may capture and decode the video output received from the video sensor video streaming interface 319 via communication channel 405. The alarm processing device video decoder/capturer 627 may also receive output from the control logic 626. The video decoder/capturer 627 may then output the video to the processor 104 for processing.

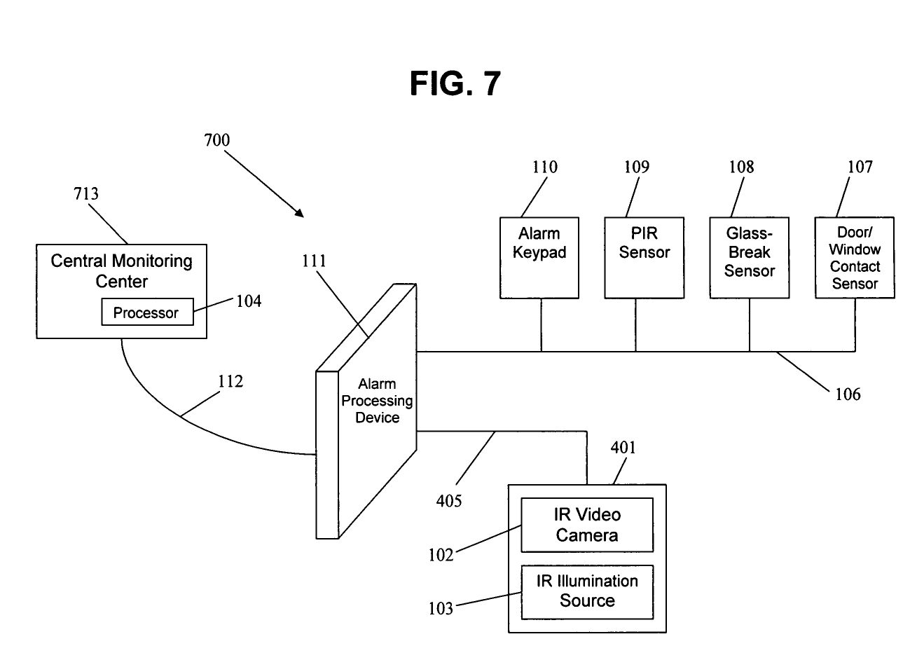

FIG. 7 schematically depicts a video-based human verification system 700 with centralized processing according to another exemplary embodiment of the invention. FIG. 7 is the same as FIG. 4 except that the processor 104 may be included in the CMC 713 as in FIG. 7 rather than in the alarm processing device 411 as in FIG. 4. The system 700 includes the “dumb” video sensor 401 that may be capable of capturing and outputting video to the alarm processing device 111 where the video may be further transmitted to the CMC 713 to determine whether a human is present in the scene.

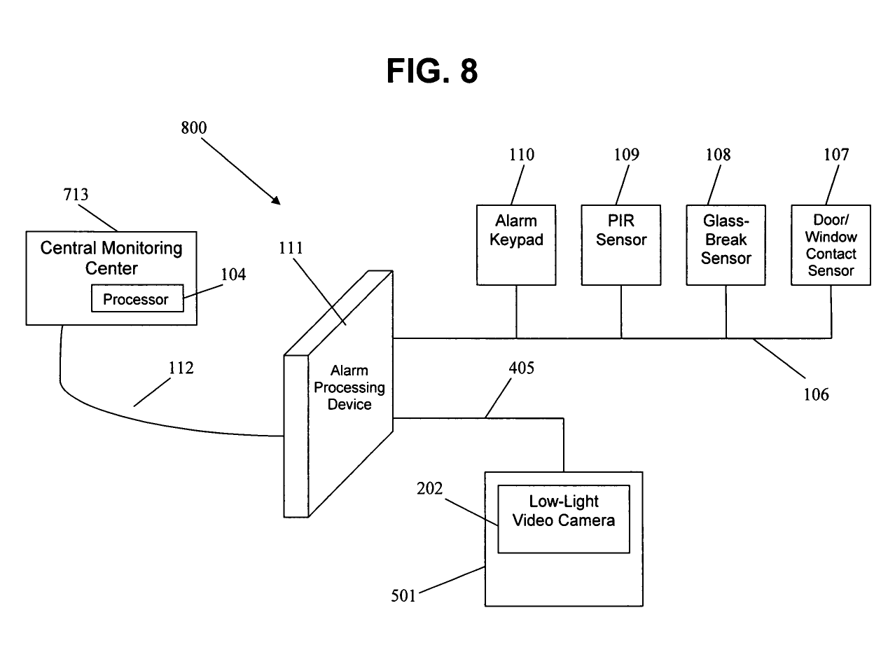

FIG. 8 schematically depicts a video-based human verification system 800 with centralized processing according to another exemplary embodiment of the invention. FIG. 8 is the same as in FIG. 7, except that “dumb” video sensor 401 may be replaced by “dumb” video sensor 501. The video sensor 501 may include the low-light video camera 202.

The software architecture for the video-based human verification system with centralized processing as shown in FIGS. 7 and 8 is the same as that depicted in FIG. 6 except that the processor 104, the content analyzer 317, the thin activity inference engine 318, the programming interface 320, and the alarm generator 323 may instead be included in the CMC 713.

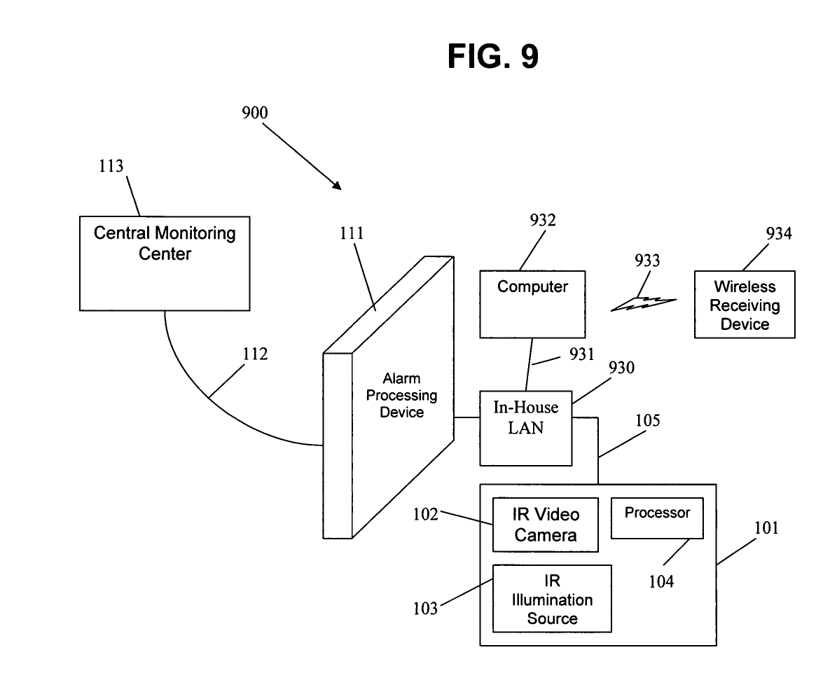

FIG. 9 schematically depicts a video-based human verification system 900 with distributed processing and customer data sharing according to an exemplary embodiment of the invention. FIG. 9 is the same as FIG. 1 except that a customer data sharing system may be included. The dry contact sensors of FIG. 1 may be included in the embodiment of FIG. 9 but are not shown. The video sensor 101 may communicate with the alarm processing device 111 and a computer 932 via the communication channel 105 and an in-house local area network (LAN) 930. In this way, for example, the video sensor data may be shared with a residential or commercial customer utilizing the video-based human verification system 900. The video sensor data may be viewed using a specific software application running on a home computer 932 connected to the LAN via a connection 931.

The video sensor data may also be shared, for example, wirelessly with the residential or commercial customer by using the home computer 932 as a server to transmit the video sensor data from the video-based human verification system 900 to one or more wireless receiving devices 934 via one or more wireless connections 933. The wireless receiving device 934 may be, for example: a computer wirelessly connected to the Internet, a laptop wirelessly connected to the Internet, a wireless PDA, a cell phone, a Blackberry, a pager, a text messaging receiving device, or any other computing device wirelessly connected to the Internet via a virtual private network (VPN) or other secure wireless connection.

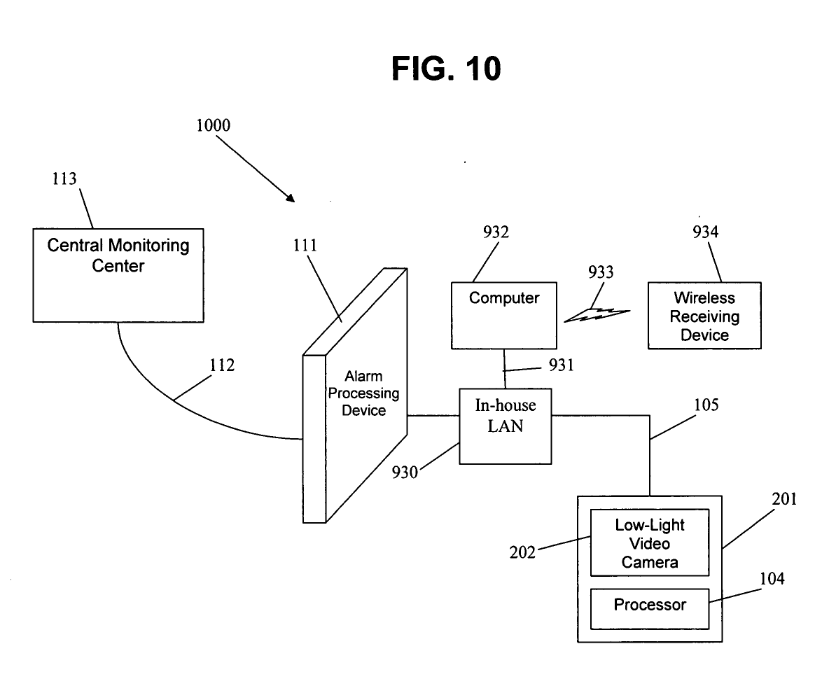

FIG. 10 schematically depicts a video-based human verification system 1000 with distributed processing and customer data sharing according to an exemplary embodiment of the invention. FIG. 10 is the same as FIG. 9 except that video sensor 101 may be replaced by “dumb” video sensor 201. The video sensor 201 may include the low-light video camera 202.

In another embodiment, data may be shared by the customer through the CMC 113. The CMC 113 may host a web-service through which subscribers may view alerts through web-pages. Alternatively, or in addition, the CMC 113 may broadcast alerts to customers via wireless alarm receiving devices. Examples of such wireless alarm receiving devices include: a cell phone, a portable laptop, a PDA, a text message receiving device, a pager, a device able to receive an email, or other wireless data receiving device.

In summary, an alarm, along with optional video and/or imagery, may be provided to the customer in a number of ways. For example, first, a home PC may host a web page for posting an alarm, along with optional video and/or imagery. Second, a home PC may provide an alarm, along with optional video and/or imagery, to a wireless receiving device. Third, a CMC may host a web page for posting an alarm, along with optional video and/or imagery. Fourth, a CMC may provide an alarm, along with optional video and/or imagery, to a wireless receiving device.

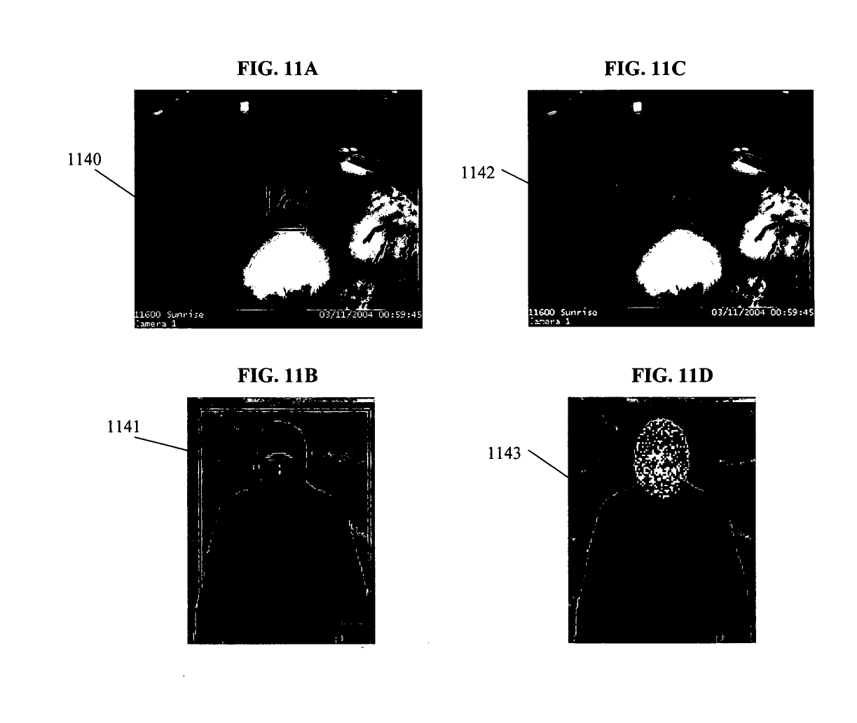

FIGS. 11A-11D show exemplary frames of video input and output within a video-based human verification system utilizing obfuscation technologies according to an exemplary embodiment of the invention. Obfuscation technologies may be utilized to protect the identity of humans captured in the video imagery. Many algorithms are known in the art for detecting the location of humans and, in particular, their faces in video imagery. Once the locations of all humans have been established (e.g., as shown in frame 1140 in FIG. 11A or in frame 1141 in FIG. 11B), the video imagery may be obfuscated, for example, by blurring, pixel shuffling, adding opaque image layers, or any other technique for obscuring imagery (e.g., as shown in frame 1142 in FIG. 11C and in frame 1143 in FIG. 11D). This may protect the identity of the individuals in the scene.

There may be three modes of operation for the obfuscation module. In a first obfuscation mode, the obfuscation technology may be on all the time. In this mode, the appearance of any human and/or their faces may be obfuscated in all imagery generated by the system. In a second obfuscation mode, the appearance of non-violators and/or their faces may be obfuscated in imagery generated by the system. In this mode, any detected violators (i.e., unknown humans) may not be obscured. In a third obfuscation mode, all humans in the view of the video camera may be obfuscated until a user specifies which humans to reveal. In this mode, once the user specifies which humans to reveal, the system may turn off obfuscation for those individuals.

In addition to obfuscating face images, it might be desirable to extract a “best face” image from the video. To achieve this, human head detection and “best face” detection may be added to the system. One technique for human head detection (as well as face detection) is discussed in, for example, U.S. patent application Ser. No. 11/139,986, titled “Human Detection and Tracking for Security Applications,” which is incorporated by reference in its entirety.

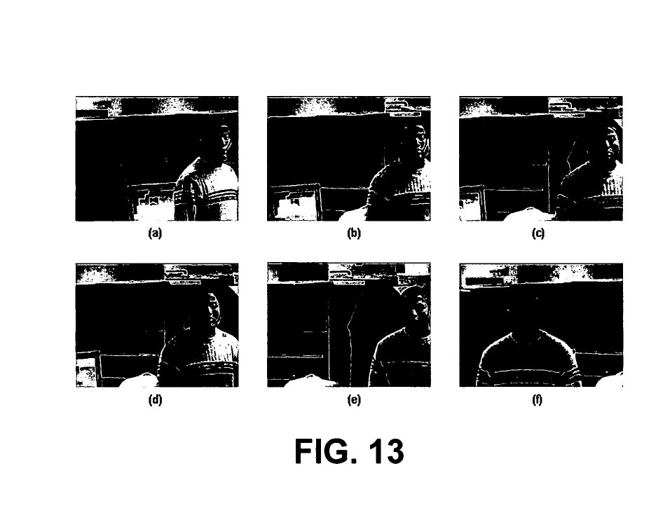

One technique for “best face” detection is as follows. Once a face has been successfully detected in the frame with the human head detection, a best shot analysis is performed on each frame with the detected face. The best shot analysis determines, for example, computes a weighted best shot score based on the following exemplary metrics: face size and skin tone ratio. With the face size metric, a large face region implies more pixels on the face, and a frame with a larger face region receives a higher score. With the skin tone ratio metric, the quality of the face shot is directly proportional to the percentage of skin-tone pixels in the face region, and a frame with a higher percentage of skin-tone pixels in the face region receives a higher score. The appropriate weighting of the metrics may be determined by testing on a generic test data set or an available test data set for the scene under consideration. The frame with the best shot score is determined to contain the best face. FIG. 13 illustrates the selection of a best face according to an exemplary embodiment of the invention.

As an alternative to the various exemplary embodiments of the invention, the system may include one or more video sensors.

As an alternative to the various exemplary embodiments of the invention, the video sensors 101, 201, 401, or 501 may communicate with an interface device instead of or in addition to communicating with the alarm processing device 111 or 411. This alternative may be useful in fitting the invention to an existing alarm system. The video sensor 101, 201, 401, or 501 may transmit video output and/or alert information to the interface device. The interface device may communicate with the CMC 113. The interface device may transmit video output and/or alert information to the CMC 113. As an option, if the video sensor 101 or 201 does not include the processor 104, the interface device or the CMC 113 may include the processor 104.

As an alternative to the various exemplary embodiments, the video sensors 101, 201, 401, or 501 may communicate with an alarm processing device 111 or 411 via a connection with a dry contact switch.

The various exemplary embodiments of the invention have been described as including an IR video camera 102 or a low-light video camera 202. Other types and combinations of video cameras may be used with the invention as will become apparent to those skilled in the art.

The exemplary embodiments and examples discussed herein are non-limiting examples.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described.

What is claimed is:

1. A video-based human, non-human, and/or motion verification system comprising:
a video sensor adapted to obtain video and produce video output, said video sensor including a video camera;
a processor adapted to process said video to verify a human presence, a non-human presence and/or motion; and
an alarm processing device coupled to said video sensor, said alarm processing device adapted to receive video output or alert information from said video sensor.

2. The video-based human, non-human, and/or motion verification system according to claim 1, wherein said video sensor includes said processor.

3. The video-based human, non-human, and/or motion verification system according to claim 2, wherein said video sensor is adapted to transmit a data packet to said alarm processing device when said processor verifies a human presence, a non-human presence, and/or motion.

4. The video-based human, non-human, and/or motion verification system according to claim 3, wherein said alarm processing device is adapted to transmit said data packet to a central monitoring center.

5. The video-based human, non-human, and/or motion verification system according to claim 4, wherein said video sensor is further adapted to transmit said data packet to a computer.

6. The video-based human, non-human, and/or motion verification system according to claim 1, further comprising at least one dry contact sensor adapted to activate said video sensor.

7. The video-based human, non-human, and/or motion verification system according to claim 6, wherein said at least one dry contact sensor is one of a passive infrared sensor, a glass-break sensor, a door contact sensor, a window contact sensor, an alarm keypad, or a motion or detection sensor.

8. The video-based human, non-human, and/or motion verification system according to claim 1, wherein said video camera of said video sensor comprises one of an infrared video camera or a low-light video camera.

9. The video-based human, non-human, and/or motion verification system according to claim 8, wherein said video camera of said video sensor is an infrared video camera and said video sensor further comprises an infrared illumination source.

10. The video-based human, non-human, and/or motion verification system according to claim 1, wherein said alarm processing device includes said processor.

11. The video-based human, non-human, and/or motion verification system according to claim 10, wherein said alarm processing device is adapted to receive said video output from said video sensor.

12. The video-based human, non-human, and/or motion verification system according to claim 11, wherein said alarm processing device is adapted to transmit an alarm and said video output to a central monitoring center when said processor verifies a human presence, a non-human presence, and/or motion.

13. The video-based human, non-human, and/or motion verification system according to claim 12, wherein said alarm processing device is further adapted to transmit a data packet to a computer.

14. The video-based human, non-human, and/or motion verification system according to claim 10, wherein said alarm processing device is adapted to obfuscate video images.

15. The video-based human, non-human, and/or motion verification system according to claim 10, wherein said alarm processing device is adapted to determine a best face shot image.

16. The video-based human, non-human, and/or motion verification system according to claim 1, wherein said alarm processing device is adapted to transmit said video output to a central monitoring center;
said central monitoring center including said processor.

17. The video-based human, non-human, and/or motion verification system according to claim 16, wherein said central monitoring center is adapted to obfuscate video images.

18. The video-based human, non-human, and/or motion verification system according to claim 16, wherein said central monitoring center is adapted to determine a best face shot image.

19. The video-based human, non-human, and/or motion verification system according to claim 16, wherein said alarm processing device is further adapted to transmit a data packet to a computer.

20. The video-based human, non-human, and/or motion verification system according to claim 1, wherein said processor is adapted to obfuscate video images.

21. The video-based human, non-human, and/or motion verification system according to claim 1, wherein said processor is adapted to determine a best face shot image.

22. The video-based human, non-human, and/or motion verification system according to claim 1, wherein said alarm processing device is adapted to forward an alarm to a computer, wherein said computer is adapted to host a web page regarding the alarm and/or adapted to transmit a message regarding the alarm to a wireless receiving device.

23. The video-based human, non-human, and/or motion verification system according to claim 1, wherein said alarm processing device is adapted to forward an alarm to a central monitoring center, wherein said central monitoring center is adapted to host a web page regarding the alarm and/or adapted to transmit a message regarding the alarm to a wireless receiving device.

24. A method for verifying a human presence, a non-human presence, and/or motion comprising utilizing the video-based human, non-human, and/or motion verification system of claim 1.

25. The video-based human verification system according to claim 1, wherein said alarm processing device is adapted to receive both video output and alert information.

26. A method for verifying a human presence, a non-human presence, and/or motion comprising:
obtaining video with a video sensor, said video sensor comprising a video camera;
producing video output with said video camera;
processing said video with a processor, said processor adapted to process said video to verify a human presence, a non-human presence, and/or motion; and
sending video output or alarm information to an alarm processing device coupled to said video sensor.
